(19) United States
(12) Patent Application Publication
(10) Pub. No.: US 2026/0011121 A1
(43) Pub. Date: Jan. 8, 2026

(54) MODEL GENERATING DEVICE AND METHOD

(71) Applicant: HTC Corporation, Taoyuan City (TW)

(72) Inventors: Chih-Jou HSU, Taoyuan City (TW); Yu-Shao PENG, Taoyuan City (TW)

(21) Appl. No.: 19/257,493

(22) Filed: Jul. 2, 2025

Related U.S. Application Data
(60) Provisional application No. 63/666,689, filed on Jul. 2, 2024.

(51) Int. Cl. G06V 10/764; G06T 7/00; G06T 11/60; G06V 10/82

(52) U.S. Cl. CPC G06V 10/764; G06T 7/0012; G06T 11/60; G06V 10/82; G06T 2207/30096

(57) ABSTRACT

A model generating device and method are provided. The device inputs strong data augmentation images corresponding to a plurality of sample images into an image restoration block in the self-supervised neural network to generate restoration inference vectors. The device generates a reconstructed image corresponding to each of the sample images based on the restoration inference vectors. The device calculates a reconstruction loss for each of the reconstructed images to train the image restoration block of the self-supervised neural network. The device inputs weak data augmentation images corresponding to the sample images into an image classification block in the self-supervised neural network to generate classification inference vectors. The device calculates a contrastive loss for the classification inference vectors based on clusters to train the image classification block of the self-supervised neural network.

### CROSS-REFERENCE TO RELATED APPLICATION

This application claims priority to U.S. Provisional Application Ser. No. 63/666,689, filed Jul. 2, 2024, which is herein incorporated by reference in its entirety.

### BACKGROUND

### Field of Invention

The present invention relates to a model generating device and method. More particularly, the present invention relates to a model generating device and method that can correctly generate a pre-trained model based on a large amount of multi-modality unlabeled medical data.

### Description of Related Art

In recent years, with the rapid development of deep learning, the determination models trained by deep learning have provided valuable auxiliary determination capabilities in many fields.

In the field of medical image analysis, accurate interpretation of images is crucial for the diagnosis and treatment of diseases. In the prior art, it has been proposed that supervised learning (SL) can be used to train models based on a large amount of labeled data. However, in the application field of medical imaging, good quality labeled medical imaging data is scarce and costly, which can make it difficult and challenging to train models with large amounts of labeled data.

In the existing self-supervised learning (SSL) technology, although the diversity of training data can be expanded through data augmentation, unlike the determination application of general natural images, the lesions in medical images usually occupy a very small area. After data augmentation, these key lesion information in the image is likely to be lost. Therefore, the existing technology lacks a model generating method that can effectively utilize unlabeled data and is suitable for medical images.

Accordingly, there is an urgent need for a model generating technology that can correctly generate a pre-trained model.

### SUMMARY

An objective of the present disclosure is to provide a model generating device. The model generating device comprises a storage, a transceiver interface, and a processor. The processor is electrically connected to the storage and the transceiver interface. The storage is configured to store a plurality of sample images and a self-supervised neural network, wherein the self-supervised neural network comprises an image restoration block and an image classification block. The processor inputs a plurality of strong data augmentation images corresponding to the plurality of sample images into the image restoration block in the self-supervised neural network to generate a plurality of restoration inference vectors. The processor generates a reconstructed image corresponding to each of the sample images based on the restoration inference vectors. The processor calculates a reconstruction loss for each of the reconstructed images to train the image restoration block of the self-supervised neural network. The processor inputs a plurality of weak data augmentation images corresponding to the sample images into the image classification block in the self-supervised neural network to generate a plurality of classification inference vectors. The processor calculates a contrastive loss for the classification inference vectors based on a plurality of clusters to train the image classification block of the self-supervised neural network.

Another objective of the present disclosure is to provide a model generating method, which is adapted for use in an electronic device. The electronic device comprises a storage, a transceiver interface, and a processor. The storage is configured to store a plurality of sample images and a self-supervised neural network, and the self-supervised neural network comprises an image restoration block and an image classification block. The model generating method comprises the following steps: inputting a plurality of strong data augmentation images corresponding to the plurality of sample images into the image restoration block in the self-supervised neural network to generate a plurality of restoration inference vectors; generating a reconstructed image corresponding to each of the sample images based on the restoration inference vectors; calculating a reconstruction loss for each of the reconstructed images to train the image restoration block of the self-supervised neural network; inputting a plurality of weak data augmentation images corresponding to the sample images into the image classification block in the self-supervised neural network to generate a plurality of classification inference vectors; and calculating a contrastive loss for the classification inference vectors based on a plurality of clusters to train the image classification block of the self-supervised neural network.

According to the above descriptions, the model generating technology (at least comprises the device and the method) provided by the present disclosure can correctly train the pre-trained model by combining the self-supervised learning process of reconstruction learning and contrastive learning at the same time. In addition, in order to simultaneously learn the complete data information and retain the information of the medical image (for example: information of the lesion), the model generating technology provided by the present disclosure limits the use of different degrees of strong data augmentation and weak data augmentation operations in different training processes. Therefore, the model generating technology provided by the present disclosure can combine the advantages of two types of self-supervised learning to correctly and efficiently generate a pre-trained model. In addition, the model generating technology provided by the present disclosure can quickly generate task models for various downstream tasks based on the trained encoder and multiple labeled data, solving the high training cost problem of the conventional technology that requires the entire task model to be re-trained. In addition, since the model generation technology provided by the present disclosure only needs to use the labeled data for fine-tuning training when training the task model, and does not need to use a large number of labeled samples when training the pre-training model, it solves the problem that the existing technology cannot correctly train the model in medical images.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view depicting a model generating device of the first embodiment;

FIG. 2 is a schematic view depicting an operation of the self-supervised neural network of the first embodiment;

FIG. 3 is a schematic view depicting an operation of the image restoration block of some embodiments;

FIG. 4 is a schematic view depicting an clustering operation of some embodiments;

FIG. 5 is a schematic view depicting an operation of the self-supervised neural network of some embodiments;

FIG. 6A is a schematic view depicting a positive sample pair of some embodiments;

FIG. 6B is a schematic view depicting a negative sample pair of some embodiments; and

FIG. 7 is a partial flowchart depicting a model generating method of the second embodiment.

### DETAILED DESCRIPTION

In the following description, a model generating device and method according to the present disclosure will be explained with reference to embodiments thereof. However, these embodiments are not intended to limit the present disclosure to any environment, applications, or implementations described in these embodiments. Therefore, description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

First, the application scenario of the present disclosure is briefly described. The present disclosure adopts a self-supervised learning architecture. In the model training process, the model does not rely on labeled data. Instead, the model generates useful feature representations by learning from the original unlabeled data to generate a trained model (e.g., a pre-trained model).

Then, in subsequent applications, users can use the model generated by the present disclosure as a basis to complete the subsequent training of downstream tasks through a small amount of target domain data (e.g., labeled or unlabeled medical images).

For example, in the target task of identifying pneumothorax, users can use large-scale chest X-ray image data to train a pre-trained model, and then perform downstream task training on a small amount of pneumothorax data to assist in image analysis.

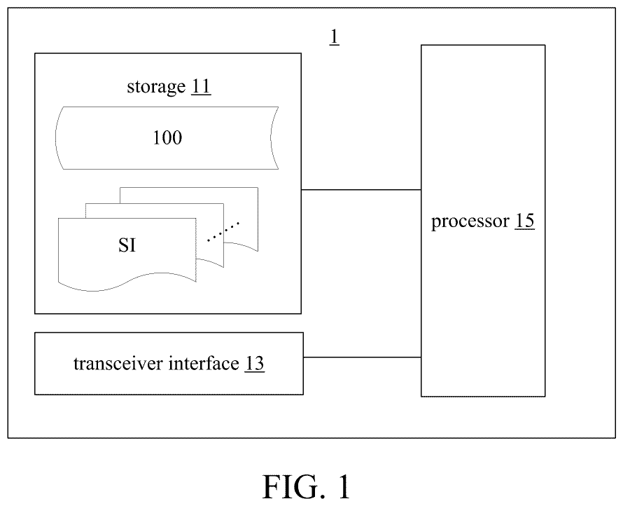

A first embodiment of the present disclosure is a model generating device 1 and a schematic view of which is depicted in FIG. 1. In the present embodiment, the model generating device 1 comprises a storage 11, a transceiver interface 13, and a processor 15, and the processor 15 is electrically connected to the storage 11 and the transceiver interface 13.

It shall be appreciated that the storage 11 may be a memory, a Universal Serial Bus (USB) disk, a hard disk, a Compact Disk (CD), a mobile disk, or any other storage medium or circuit known to those of ordinary skill in the art and having the same functionality. The transceiver interface 13 is an interface capable of receiving and transmitting data or other interfaces capable of receiving and transmitting data and known to those of ordinary skill in the art. The transceiver interface 13 can receive data from sources such as external devices, external web pages, external applications, and so on. The processor 15 may be any of various processors, Central Processing Units (CPUs), microprocessors, digital signal processors or other computing devices known to those of ordinary skill in the art.

In the present embodiment, as shown in FIG. 1, the storage 11 can be used to store a plurality of sample images SI and a self-supervised neural network 100.

It shall be appreciated that the self-supervised neural network 100 is initially an untrained initial model. In the present disclosure, the model generating device 1 will train the self-supervised neural network 100 through the mechanism of the present disclosure, and the trained self-supervised neural network 100 is used as the pre-trained model. In some embodiments, the model generating device 1 can obtain some component contents (e.g., encoders for feature extraction and decoders) in the self-supervised neural network 100 as basic components for subsequent training according to application needs. The specific contents and implementation details of the self-supervised neural network 100 will be described in detail later.

The operation of the first embodiment of the present disclosure may mainly include three stages of operation, namely, the training sample generating stage, the pre-training stage, and the fine-tuning stage. It should be appreciated that the present disclosure mainly focuses on the training sample generating stage and the pre-training stage of the model. In subsequent applications, the fine-tuning stage may be performed based on the trained model.

It shall be appreciated that the training sample generating stage mainly generates strong data augmentation images and weak data augmentation images corresponding to the sample images SI. The pre-training stage mainly trains the self-supervised neural network 100 in this stage. Finally, in the fine-tuning stage, depending on the application requirements, the trained self-supervised neural network 100 can be connected to a new downstream model, or the encoder and decoder in the self-supervised neural network 100 can be extracted for subsequent application.

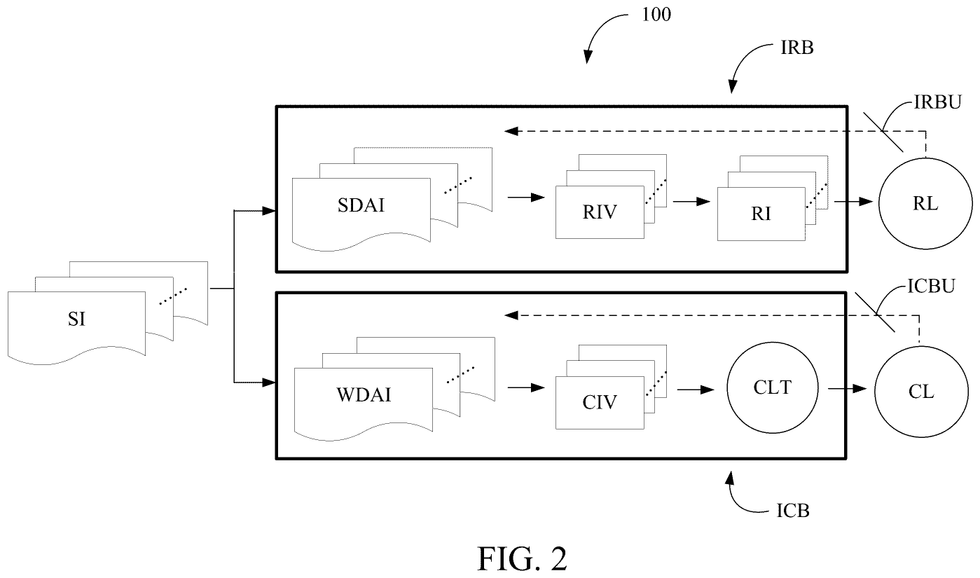

The following paragraphs will explain the implementation details related to the present disclosure in detail. For ease of understanding, the operation of the first embodiment of the present disclosure is briefly described first. Please refer to the operation diagram of the self-supervised neural network 100 in FIG. 2. As shown in FIG. 2, the self-supervised neural network 100 includes an image restoration block IRB and an image classification block ICB.

In the present embodiment, the model generating device 1 simultaneously trains the image restoration block IRB and the image classification block ICB in the self-supervised neural network 100 through the mechanism disclosed herein.

First, in the present embodiment, the processor 15 generates a plurality of strong data augmentation images SDAI and a plurality of weak data augmentation images WDAI corresponding to the sample images SI.

In some embodiments, the processor 15 performs a high degree deformation or conversion operation and a random masking operation on each of the sample images SI to generate the strong data augmentation images SDAI corresponding to the sample images SI.

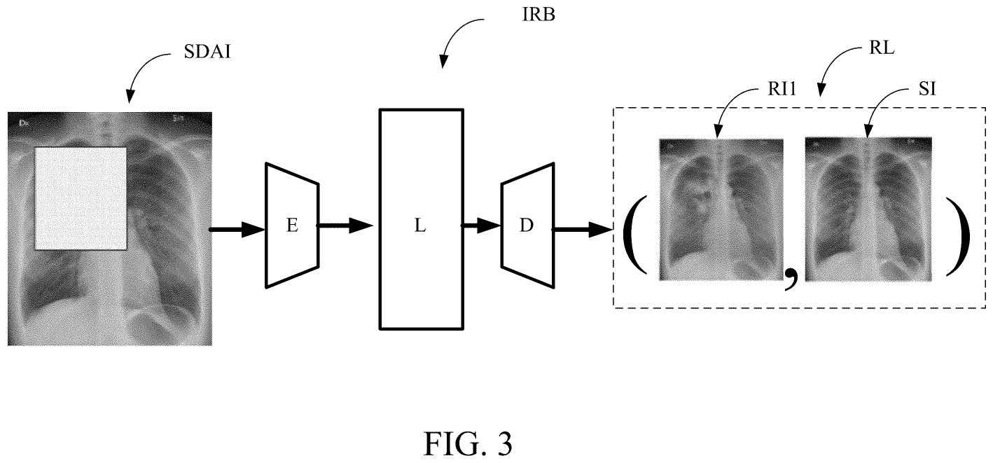

For example, FIG. 3 illustrates a strong data augmentation image SDAI. In the present example, some blocks in the chest image are removed/masked.

It shall be appreciated that strong data augmentation is a technology that highly deforms and transforms images, which will significantly change the distribution of image pixels and even obscure or mix multiple images.

For example, strong data augmentation may include but is not limited to randomly masking parts of the image (Cutout), randomly cropping a large area and scaling (Random Resized Crop), high-level brightness/contrast/saturation perturbations (High-level Color Jitter), applying a strong blur (High-level Gaussian Blur (σ>1.0)), and randomly selecting multiple perturbations from a set of strong perturbation strategies and applying them to the image (RandAugment).

In some embodiments, the processor 15 performs a slight deformation operation on each of the sample images SI to generate the weak data augmentation images WDAI corresponding to the sample images SI.

It shall be appreciated that weak data augmentation is a technique that slightly deforms the original image. The characteristic of weak data augmentation is that it does not destroy the semantic content of the original image, while retaining the main structure and identification features of the image.

For example, weak data augmentation may include but is not limited to random left/right/horizontal/vertical flipping, rotation, resizing only, random cropping of a small area and resizing back to the original size (Random Crop+Resize), retaining the central main part (Center Crop), slight image translation (Small Translation), slight adjustment of brightness, contrast, saturation (Low-level Color Jitter), adding slight noise (Low-level Gaussian Blur).

It shall be appreciated that in the present disclosure, strong data augmentation or weak data augmentation can be distinguished from the perspective of whether the semantic content of the original image is destroyed, that is, whether important information is still retained after data augmentation. In medical images, a possible example is whether the lesion still exists. In some embodiments, a deformation degree of the strong data augmentation images SDAI is greater than the deformation degree of the weak data augmentation images WDAI.

Next, in the present embodiment, as shown in FIG. 2, the processor 15 inputs the strong data augmentation images SDAI and the weak data augmentation images WDAI into the image restoration block IRB and the image classification block ICB in the self-supervised neural network 100, respectively, for subsequent training operations.

For ease of understanding, the following will first describe the operations in the image restoration block IRB. It shall be appreciated that the operations of the image restoration block IRB and the image classification block ICB can be performed simultaneously in parallel.

First, the processor 15 inputs a plurality of strong data augmentation images SDAI corresponding to the sample images SI into the image restoration block IRB in the self-supervised neural network 100 to generate a plurality of restoration inference vectors RIV.

Then, in the present embodiment, the processor 15 generates a reconstructed image RI corresponding to each of the sample images SI based on the restoration inference vectors RIV. Finally, the processor 15 calculates the reconstruction loss RL of each of the reconstructed images RI to train the image restoration block IRB of the self-supervised neural network 100.

It shall be appreciated that the reconstruction loss RL is used to measure the gap between the reconstruction result output by the model and the original input. The goal is to allow the model to learn to capture the structural or semantic features of the input data. For example, the reconstruction loss function can be expressed by the following equation (with Mean Squared Error (L_MSE) as the reconstruction loss RL):

$$ℒ MSE = \frac{1}{n} {\sum }_{i = 1}^{n} {( {x}_{i} - {\hat{x}}_{i} )}^{2}$$

The parameter xᵢ is the pixel value of the original image, parameter \hat{x}ᵢ; is the pixel value reconstructed by the model, and parameter n is the total number of pixels in the image.

For ease of understanding, please refer to the operation of an image restoration block shown in FIG. 3. In the present example, the processor 15 inputs a strongly data augmentation image SDAI corresponding to the sample image SI into the image restoration block IRB in the self-supervised neural network 100. The processor 15 generates a reconstructed image RI1 corresponding to the strongly data augmentation image SDAI through the encoder E, the latent space L, and the decoder D in the image restoration block IRB. Then, the processor 15 calculates the reconstruction loss RL of the reconstructed image RI1 (i.e., the difference between the reconstructed image RI1 and the original sample image SI) to train the image restoration block IRB of the self-supervised neural network 100.

Next, the operations in the image classification block ICB will be described below.

In the present embodiment, the processor 15 inputs a plurality of weak data augmentation images WDAI corresponding to the sample images SI into the image classification block ICB in the self-supervised neural network 100 to generate a plurality of classification inference vectors CIV.

Next, the processor 15 performs a clustering operation CLT and calculates the contrastive loss CL of the classification inference vectors CIV based on a plurality of clusters to train the image classification block ICB of the self-supervised neural network 100.

In some embodiments, the processor 15 generates a plurality of positive samples and a plurality of negative samples corresponding to the sample images SI based on the clusters. Finally, the processor 15 calculates a contrastive loss of the classification inference vector based on a plurality of positive sample pairs and a plurality of negative sample pairs to train the image classification block ICB of the self-supervised neural network 100.

In some embodiments, the clusters are generated by a plurality of historical data and a plurality of data modes. In the contrastive learning process, the processor 15 can perform a clustering operation in the feature space to group the data points into K clusters according to their similarities.

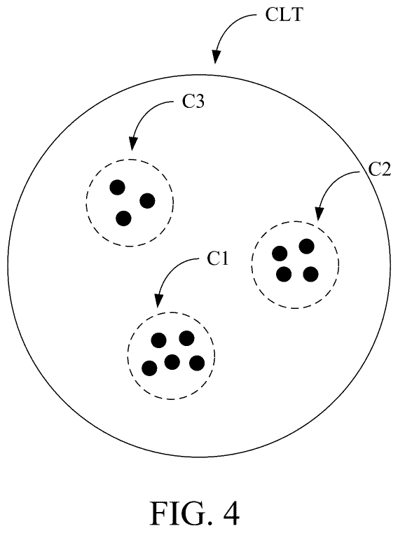

For easier understanding, please refer to a clustering operation diagram shown in FIG. 4. In the present example, the processor 15 may pre-set a clustering K value to determine the number of clusters, where K is a positive integer.

In the present example, the clustering operation CLT executed by the processor 15 divides the plurality of historical data points into the C1 modality category, the C2 modality category and the C3 modality category. Each category can represent a modality of captured images (e.g., X-Ray1 image, X-Ray2 image, and CT image). Samples within the same modality category constitute positive sample pairs, and samples between different modality categories constitute negative sample pairs. For example, different augmentation versions of X-Ray1 constitute positive sample pairs, while samples of X-Ray1 and CT constitute negative sample pairs.

It shall be appreciated that in the mechanism provided by the present disclosure, by adding a clustering operation, the processor 15 can use the modality category information of the data set itself to provide more pseudo-labels, so that the model can learn more rich information.

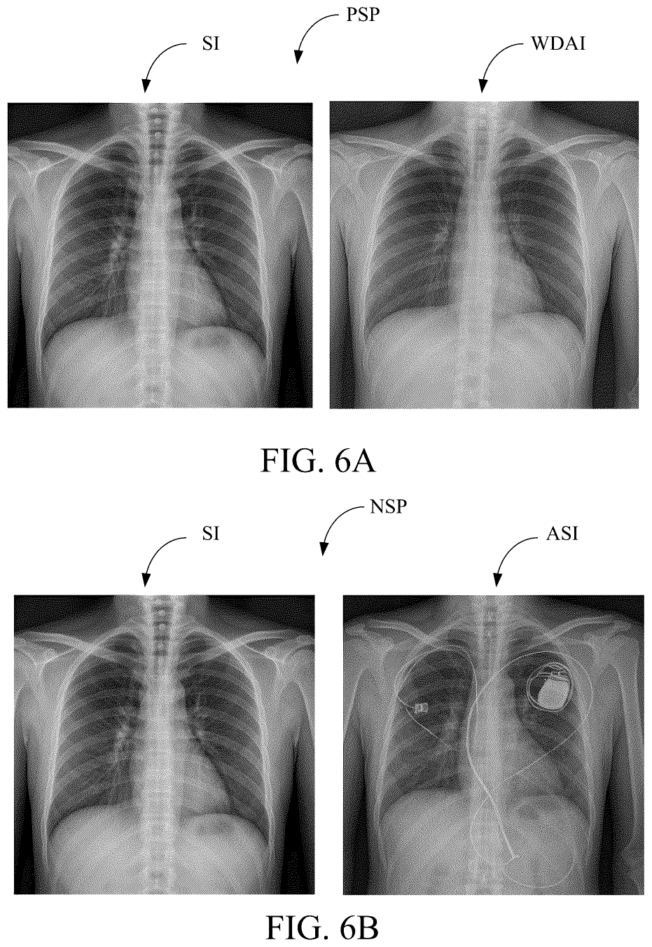

For example, FIG. 6A illustrates a positive sample pair PSP consisting of a sample image SI and a weak data augmentation image WDAI corresponding to the sample image SI (e.g., by slight brightness adjustment). FIG. 6B illustrates a negative sample pair NSP consisting of a sample image SI and another sample image ASI.

It shall be appreciated that contrastive loss CL is usually used to train the model through positive sample pairs and negative sample pairs. Positive sample pairs are images with the same semantics, such as different augmentation versions of the same picture. Negative sample pairs are images with different semantics, such as different pictures. The goal of the model is to narrow the representation distance between positive sample pairs (similar) and expand the representation distance between negative sample pairs (dissimilar). For example, the contrastive loss function can be expressed by the following equation:

$${ℒ}_{i , j} = - log \frac{exp ( si m ( {z}_{i ′} {z}_{j} ) / τ )}{{Σ}_{k = 1}^{2 N} {1}_{[ k \neq i ]} exp ( s i m ( {z}_{i} , {z}_{k} ) / τ )}$$

The parameters zᵢ and zⱼ are the embeddings from the positive sample pairs, the function sim(·) is the cosine similarity, the parameter t is the temperature parameter that controls the sharpness of the distribution, and the parameter N is the batch size and there is one pair for each example.

In the present embodiment, the processor 15 can update the image restoration block IRB and the image classification block ICB by executing the image restoration block update IRBU and the image classification block update ICBU (for example, returning the update gradient to update the parameters).

In some embodiments, part of the architecture of the self-supervised neural network 100 used in the present disclosure may adopt the self-supervised neural network used in the MoCov2 architecture.

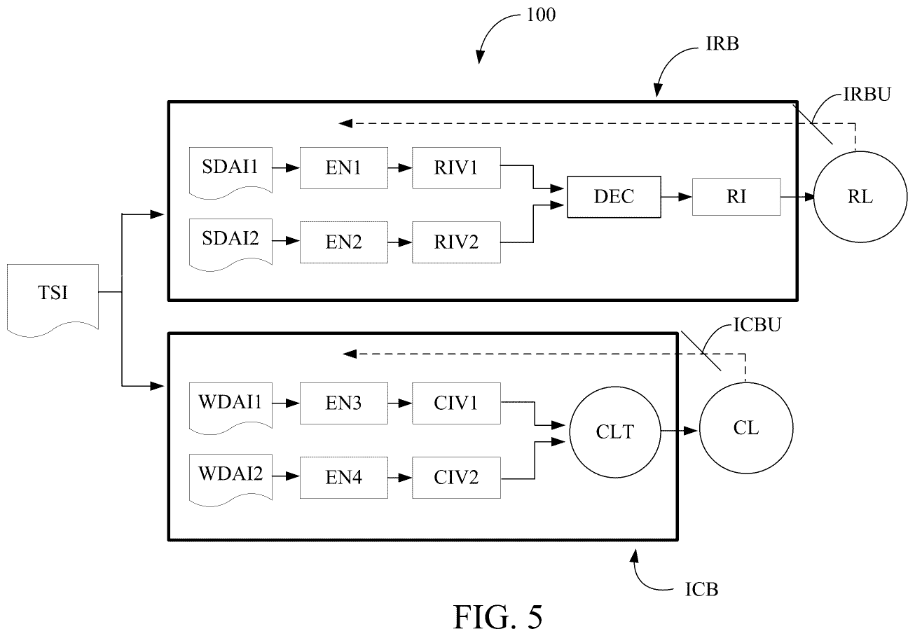

In some embodiments, the image restoration block IRB and the image classification block ICB can be processed in parallel by two encoders to improve the accuracy of training. For ease of understanding, please refer to the operation diagram of a self-supervised neural network 100 shown in FIG. 5, taking a target sample image TSI among the sample images SI as an example.

First, the operation of the image restoration block IRB is described. In the present example, the image restoration block IRB includes a first encoder EN1, a second encoder EN2, and a decoder DEC. Specifically, the processor 15 inputs a first strongly data augmentation image SDAI1 corresponding to a target sample image TSI to the first encoder EN1 in the self-supervised neural network 100 to generate a first restoration inference vector RIV1, and the target sample image TSI is one of the sample images SI.

Next, the processor 15 inputs a second strongly data augmentation image SDAI2 corresponding to the target sample image TSI into the second encoder EN2 in the self-supervised neural network 100 to generate a second restored inference vector RIV2.

Next, the processor 15 inputs the first restoration inference vector RIV1 and the second restoration inference vector RIV2 to the decoder DEC in the self-supervised neural network 100 to generate a reconstructed image RI corresponding to the target sample image TSI. Finally, the processor 15 calculates the reconstruction loss of the reconstructed image RI corresponding to the target sample image TSI to train the image restoration block IRB of the self-supervised neural network 100.

It shall be appreciated that since the first restoration inference vector RIV1 and the second restoration inference vector RIV2 both carry partial information of the target sample image TSI, the reconstructed image RI can be generated more accurately during training, thereby improving the training efficiency.

In some embodiments, the image restoration block IRB is composed of a backbone network and a momentum network, and during the training phase, the backbone network is assisted in training by the momentum network to adjust the weights and parameters of the backbone network for feature extraction of certain image blocks. Specifically, the second encoder EN2 is a momentum encoder, and the momentum encoder is updated by a preset momentum method.

For example, unlike the amplitude of the backbone network update, the momentum network will be updated through the following equation:

$${f}_{ξ} = m \cdot {f}_{ξ} + ( 1 - m ) {f}_{θ}$$

The parameter f_{θ} is the backbone network, the parameter f_{ξ} is the momentum network, and the parameter m ranges from 0 to 1. It can usually be set to 0.999, which means that most of the original model parameters are retained, and only a small part refers to the updated backbone network.

Next, the operation of the image classification block ICB is described. In the present example, the image classification block ICB comprises a third encoder EN3 and a fourth encoder EN4. Specifically, the processor 15 inputs the first weak data augmentation image WDAI1 corresponding to the target sample image TSI to the third encoder EN3 in the self-supervised neural network 100 to generate a first classification inference vector CIV1, and the target sample image TSI is one of the sample images SI. Then, the processor 15 inputs the second weak data augmentation image WDAI2 corresponding to the target sample image TSI to the fourth encoder EN4 in the self-supervised neural network 100 to generate a second classification inference vector CIV2.

Next, the processor 15 performs a clustering operation CLT, and based on the clusters, the processor 15 generates a plurality of positive samples and a plurality of negative samples corresponding to the target sample image TSI. Finally, the processor 15 calculates, based on the plurality of positive sample pairs and the plurality of negative sample pairs, the contrastive loss CL of the first classification inference vector CIV1 and the second classification inference vector CIV2 to train the image classification block ICB of the self-supervised neural network 100.

In some embodiments, the image classification block ICB is composed of a backbone network and a momentum network, and during the training phase, the backbone network is assisted in training by the momentum network to adjust the weights and parameters of the backbone network for feature extraction of certain image blocks. Specifically, the fourth encoder EN4 is a momentum encoder, and the momentum encoder is updated by a preset momentum method (e.g., the equation in the above example).

In some embodiments, the processor 15, based on the image restoration block IRB, the image classification block ICB in the self-supervised neural network 100, and a plurality of labeled data corresponding to a lesion feature, generates a task model for determining the lesion feature.

In some embodiments, after the self-supervised neural network 100 is trained (i.e., all corresponding training data have been trained), since the encoder has the ability to extract features, in the fine-tuning stage, the processor 15 can use the encoder in the self-supervised neural network 100 as the basis for feature extraction, and then fine-tune other newly added layers corresponding to different applications (e.g., fully connected layers, decoders, etc.) to generate a task model.

According to the above descriptions, the model generating device 1 provided by the present disclosure can correctly train the pre-trained model by combining the self-supervised learning process of reconstruction learning and contrastive learning at the same time. In addition, in order to simultaneously learn the complete data information and retain the information of the medical image (for example: information of the lesion), the model generating device 1 provided by the present disclosure limits the use of different degrees of strong data augmentation and weak data augmentation operations in different training processes. Therefore, the model generating device 1 provided by the present disclosure can combine the advantages of two types of self-supervised learning to correctly and efficiently generate a pre-trained model. In addition, the model generating device 1 provided by the present disclosure can quickly generate task models for various downstream tasks based on the trained encoder and multiple labeled data, solving the high training cost problem of the conventional technology that requires the entire task model to be re-trained. In addition, since the model generation technology provided by the present disclosure only needs to use the labeled data for fine-tuning training when training the task model, and does not need to use a large number of labeled samples when training the pre-training model, it solves the problem that the existing technology cannot correctly train the model in medical images.

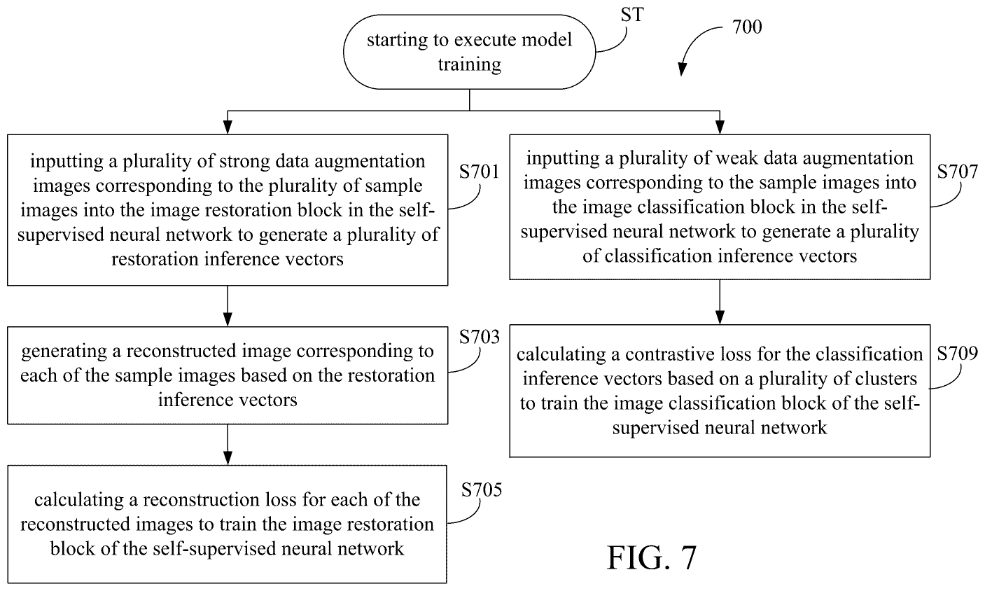

A second embodiment of the present invention is a model generating method and a flowchart thereof is depicted in FIG. 7. The model generating method 700 is adapted for use in an electronic device. The electronic device comprises a storage, a transceiver interface, and a processor (e.g., the model generating device 1 of the first embodiment). The electronic device may store a plurality of sample images and a self-supervised neural network, the self-supervised neural network comprises an image restoration block and an image classification block (e.g., the self-supervised neural network 100 of the first embodiment). The model generating method 700 training the self-supervised neural network through the step ST and the steps S701 to S709.

It shall be appreciated that the steps S701, S703, and S705 in the model generating method 700 are steps for training the image restoration block in the self-supervised neural network. The steps S707 and S709 in the model generating method 700 are steps for training the image classification block in the self-supervised neural network. The two training processes (i.e., “the steps S701, S703, and S705” and “the steps S707 and S709”) can be executed in parallel.

First, in the step ST, the electronic device starts to execute model training. In the step S701, the electronic device inputs a plurality of strong data augmentation images corresponding to the plurality of sample images into the image restoration block in the self-supervised neural network to generate a plurality of restoration inference vectors.

Next, in the step S703, the electronic device generates a reconstructed image corresponding to each of the sample images based on the restoration inference vectors.

Next, in the step S705, the electronic device calculates a reconstruction loss for each of the reconstructed images to train the image restoration block of the self-supervised neural network.

Furthermore, in the step S707, the electronic device inputs a plurality of weak data augmentation images corresponding to the sample images into the image classification block in the self-supervised neural network to generate a plurality of classification inference vectors.

Next, in the step S709, the electronic device calculates a contrastive loss for the classification inference vectors based on a plurality of clusters to train the image classification block of the self-supervised neural network.

In some embodiments, the model generating method 700 further comprises the following steps: performing a high degree deformation or conversion operation and a random masking operation on each of the sample images to generate the plurality of strong data augmentation images corresponding to the sample images.

In some embodiments, wherein the model generating method 700 comprises the following steps: performing a slight deformation operation on each of the sample images to generate the weak data augmentation images corresponding to the sample images.

In some embodiments, wherein a deformation degree of the strong data augmentation images is greater than the deformation degree of the weak data augmentation images.

In some embodiments, wherein the image restoration block comprises a first encoder, a second encoder, and a decoder, and the model generating method 700 comprises the following steps: inputting a first strong data augmentation image corresponding to a target sample image into the first encoder in the self-supervised neural network to generate a first restoration inference vector, wherein the target sample image is one of the sample images; inputting a second strong data augmentation image corresponding to the target sample image into the second encoder in the self-supervised neural network to generate a second restoration inference vector; inputting the first restoration inference vector and the second restoration inference vector into the decoder in the self-supervised neural network to generate the reconstructed image corresponding to the target sample image; and calculating the reconstruction loss of the reconstructed image corresponding to the target sample image to train the image restoration block of the self-supervised neural network.

In some embodiments, wherein the second encoder is a momentum encoder, and the momentum encoder is updated by a preset momentum method.

In some embodiments, wherein the clusters are generated by a plurality of historical data and a plurality of data modes.

In some embodiments, wherein the image classification block comprises a third encoder and a fourth encoder, and the model generating method 700 comprises the following steps: inputting a first weak data augmentation image corresponding to a target sample image into the third encoder in the self-supervised neural network to generate a first classification inference vector, wherein the target sample image is one of the sample images; inputting a second weak data augmentation image corresponding to the target sample image into the fourth encoder in the self-supervised neural network to generate a second classification inference vector; generating a plurality of positive samples and a plurality of negative samples corresponding to the target sample image based on the clusters; and calculating, based on a plurality of positive sample pairs and a plurality of negative sample pairs, the contrastive loss of the first classification inference vector and the second classification inference vector to train the image classification block of the self-supervised neural network.

In some embodiments, wherein the fourth encoder is a momentum encoder, and the momentum encoder is updated by a preset momentum method.

In some embodiments, wherein the model generating method 700 further comprises the following steps: generating, based on the image restoration block, the image classification block in the self-supervised neural network, and a plurality of labeled data corresponding to a lesion feature, a task model for determining the lesion feature.

In addition to the aforesaid steps, the second embodiment can also execute all the operations and steps of the model generating device 1 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present invention, some words (e.g., the encoder, the strong data augmentation image, the restoration inference vector, the weak data augmentation image, and the classification inference vector) are preceded by terms such as “first”, “second”, “third”, or “fourth,” and these terms of “first”, “second”, “third”, and “fourth” are only used to distinguish these different words. For example, the “first” and “second” in the first restoration inference vector and the second restoration inference vector are only used to indicate the restoration inference vector generated by different encoders.

According to the above descriptions, the model generating technology (at least comprises the device and the method) provided by the present disclosure can correctly train the pre-trained model by combining the self-supervised learning process of reconstruction learning and contrastive learning at the same time. In addition, in order to simultaneously learn the complete data information and retain the information of the medical image (for example: information of the lesion), the model generating technology provided by the present disclosure limits the use of different degrees of strong data augmentation and weak data augmentation operations in different training processes. Therefore, the model generating technology provided by the present disclosure can combine the advantages of two types of self-supervised learning to correctly and efficiently generate a pre-trained model. In addition, the model generating technology provided by the present disclosure can quickly generate task models for various downstream tasks based on the trained encoder and multiple labeled data, solving the high training cost problem of the conventional technology that requires the entire task model to be re-trained. In addition, since the model generation technology provided by the present disclosure only needs to use the labeled data for fine-tuning training when training the task model, and does not need to use a large number of labeled samples when training the pre-training model, it solves the problem that the existing technology cannot correctly train the model in medical images.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A model generating device, comprising:
a storage, being configured to store a plurality of sample images and a self-supervised neural network, wherein the self-supervised neural network comprises an image restoration block and an image classification block;
a transceiver interface; and
a processor, being electrically connected to the storage and the transceiver interface, and being configured to perform operations comprising:
inputting a plurality of strong data augmentation images corresponding to the plurality of sample images into the image restoration block in the self-supervised neural network to generate a plurality of restoration inference vectors;
generating a reconstructed image corresponding to each of the sample images based on the restoration inference vectors;
calculating a reconstruction loss for each of the reconstructed images to train the image restoration block of the self-supervised neural network;
inputting a plurality of weak data augmentation images corresponding to the sample images into the image classification block in the self-supervised neural network to generate a plurality of classification inference vectors; and
calculating a contrastive loss for the classification inference vectors based on a plurality of clusters to train the image classification block of the self-supervised neural network.

2. The model generating device of claim 1, wherein the processor is configured to perform the following operations:
performing a high degree deformation or conversion operation and a random masking operation on each of the sample images to generate the plurality of strong data augmentation images corresponding to the sample images.

3. The model generating device of claim 1, wherein the processor is configured to perform the following operations:
performing a slight deformation operation on each of the sample images to generate the weak data augmentation images corresponding to the sample images.

4. The model generating device of claim 1, wherein a deformation degree of the strong data augmentation images is greater than the deformation degree of the weak data augmentation images.

5. The model generating device of claim 1, wherein the image restoration block comprises a first encoder, a second encoder, and a decoder, and the processor performs the following operations:
inputting a first strong data augmentation image corresponding to a target sample image into the first encoder in the self-supervised neural network to generate a first restoration inference vector, wherein the target sample image is one of the sample images;
inputting a second strong data augmentation image corresponding to the target sample image into the second encoder in the self-supervised neural network to generate a second restoration inference vector;
inputting the first restoration inference vector and the second restoration inference vector into the decoder in the self-supervised neural network to generate the reconstructed image corresponding to the target sample image; and
calculating the reconstruction loss of the reconstructed image corresponding to the target sample image to train the image restoration block of the self-supervised neural network.

6. The model generating device of claim 5, wherein the second encoder is a momentum encoder, and the momentum encoder is updated by a preset momentum method.

7. The model generating device of claim 1, wherein the clusters are generated by a plurality of historical data and a plurality of data modes.

8. The model generating device of claim 1, wherein the image classification block comprises a third encoder and a fourth encoder, and the processor performs the following operations:
inputting a first weak data augmentation image corresponding to a target sample image into the third encoder in the self-supervised neural network to generate a first classification inference vector, wherein the target sample image is one of the sample images;
inputting a second weak data augmentation image corresponding to the target sample image into the fourth encoder in the self-supervised neural network to generate a second classification inference vector;
generating a plurality of positive samples and a plurality of negative samples corresponding to the target sample image based on the clusters; and
calculating, based on a plurality of positive sample pairs and a plurality of negative sample pairs, the contrastive loss of the first classification inference vector and the second classification inference vector to train the image classification block of the self-supervised neural network.

9. The model generating device of claim 8, wherein the fourth encoder is a momentum encoder, and the momentum encoder is updated by a preset momentum method.

10. The model generating device of claim 1, wherein the processor further performs the following operations:
generating, based on the image restoration block, the image classification block in the self-supervised neural network, and a plurality of labeled data corresponding to a lesion feature, a task model for determining the lesion feature.

11. A model generating method, being adapted for use in an electronic device, wherein the electronic device comprises a storage, a transceiver interface, and a processor, the storage is configured to store a plurality of sample images and a self-supervised neural network, the self-supervised neural network comprises an image restoration block and an image classification block, and the model generating method comprises the following steps:
inputting a plurality of strong data augmentation images corresponding to the plurality of sample images into the image restoration block in the self-supervised neural network to generate a plurality of restoration inference vectors;
generating a reconstructed image corresponding to each of the sample images based on the restoration inference vectors;
calculating a reconstruction loss for each of the reconstructed images to train the image restoration block of the self-supervised neural network;
inputting a plurality of weak data augmentation images corresponding to the sample images into the image classification block in the self-supervised neural network to generate a plurality of classification inference vectors; and
calculating a contrastive loss for the classification inference vectors based on a plurality of clusters to train the image classification block of the self-supervised neural network.

12. The model generating method of claim 11, wherein the model generating method comprises the following steps:
performing a high degree deformation or conversion operation and a random masking operation on each of the sample images to generate the plurality of strong data augmentation images corresponding to the sample images.

13. The model generating method of claim 11, wherein the model generating method comprises the following steps:
performing a slight deformation operation on each of the sample images to generate the weak data augmentation images corresponding to the sample images.

14. The model generating method of claim 11, wherein a deformation degree of the strong data augmentation images is greater than the deformation degree of the weak data augmentation images.

15. The model generating method of claim 11, wherein the image restoration block comprises a first encoder, a second encoder, and a decoder, and the model generating method comprises the following steps:
inputting a first strong data augmentation image corresponding to a target sample image into the first encoder in the self-supervised neural network to generate a first restoration inference vector, wherein the target sample image is one of the sample images;
inputting a second strong data augmentation image corresponding to the target sample image into the second encoder in the self-supervised neural network to generate a second restoration inference vector;
inputting the first restoration inference vector and the second restoration inference vector into the decoder in the self-supervised neural network to generate the reconstructed image corresponding to the target sample image; and
calculating the reconstruction loss of the reconstructed image corresponding to the target sample image to train the image restoration block of the self-supervised neural network.

16. The model generating method of claim 15, wherein the second encoder is a momentum encoder, and the momentum encoder is updated by a preset momentum method.

17. The model generating method of claim 11, wherein the clusters are generated by a plurality of historical data and a plurality of data modes.

18. The model generating method of claim 11, wherein the image classification block comprises a third encoder and a fourth encoder, and the model generating method comprises the following steps:
inputting a first weak data augmentation image corresponding to a target sample image into the third encoder in the self-supervised neural network to generate a first classification inference vector, wherein the target sample image is one of the sample images;
inputting a second weak data augmentation image corresponding to the target sample image into the fourth encoder in the self-supervised neural network to generate a second classification inference vector;
generating a plurality of positive samples and a plurality of negative samples corresponding to the target sample image based on the clusters; and
calculating, based on a plurality of positive sample pairs and a plurality of negative sample pairs, the contrastive loss of the first classification inference vector and the second classification inference vector to train the image classification block of the self-supervised neural network.

19. The model generating method of claim 18, wherein the fourth encoder is a momentum encoder, and the momentum encoder is updated by a preset momentum method.

20. The model generating method of claim 11, wherein the model generating method further comprises the following steps:
generating, based on the image restoration block, the image classification block in the self-supervised neural network, and a plurality of labeled data corresponding to a lesion feature, a task model for determining the lesion feature.
